(19) United States
(12) Patent Application Publication
(10) Pub. No.: US 2012/0039785 A1
(43) Pub. Date: Feb. 16, 2012

(54) Process for Producing Products Under Very Low Supersaturation

(75) Inventor: Shoulian Zhu, Jacksonville, FL (US)

(73) Assignee: Wellthought Products, Inc., Jacksonville, FL (US)

(21) Appl. No.: 12/853,586

(22) Filed: Aug. 10, 2010

(51) Int. Cl. C01B 25/163; B01J 19/00

(52) U.S. Cl. 423/320; 422/224

(57) ABSTRACT

Disclosed is a process for any productions that involve reacting or mixing two or more substances to form one or more new substances under low supersaturation. However, the specific process used to exemplify the present invention is the “wet process” phosphoric acid production, in which this process is achieved through dissolving the phosphate ore and dispersing the sulfuric acid separately and simultaneously with the gypsum slurry that has roughly stoichiometrically balanced calcium and sulfate ions in the solution and is also at considerably low supersaturation. The slurry carried out digesting the phosphate ore and the slurry accomplished dispersing the sulfuric acid then mix together to form the said gypsum slurry that has roughly stoichiometrically balanced calcium and sulfate ions in the solution and is also at considerably low supersaturation. The slurry for filtration is drawn from the sulfuric acid dispersion compartment, and the sulfate level for this slurry is maintained suitable for the product separation.

### REFERENCES CITED

### US Patent Documents

| | | |
|---|---|---|
| 1,836,672 | December 1931 | Larson |
| 2,885,264 | May 1959 | Peet |
| 2,968,544 | January 1961 | Zeitz, et al. |
| 3,257,168 | June 1966 | Chelminski |
| 3,418,077 | December 1968 | Robinson |
| 3,453,076 | July 1969 | Long, et al. |
| 3,522,003 | July 1970 | Lopker |
| 3,522,004 | July 1970 | Lopker |
| 3,917,457 | November 1975 | Bergstrom |
| 3,939,248 | February 1976 | Caldwell |
| 4,205,046 | May 1980 | Popovici |
| 4,260,584 | April 1981 | Ore, et al. |
| 4,276,270 | June 1981 | Gragg, et al. |
| 4,277,448 | July 1981 | Ore, et al. |
| 4,298,583 | November 1981 | Davister, et al. |
| 4,309,395 | June 1982 | Hauge |
| 4,363,786 | December 1982 | Adams, et al. |
| 4,524,057 | June 1985 | Bigot |
| 4,743,438 | May 1988 | Kennedy, et al. |
| 4,828,811 | May 1989 | Derdall, et al. |

### BACKGROUND

This invention relates to any processes that involve reacting or mixing two or more substances to form one or more new substances under low supersaturation. However, the specific process used to exemplify the present invention is the “wet process” phosphoric acid production, where phosphate ore is reacted with sulfuric acid to form the product phosphoric acid and the byproduct gypsum. The byproduct gypsum is then separated from the product phosphoric acid through filtration.

Depending on the reaction conditions, there are mostly two types of gypsum crystals formed in the “wet process” phosphoric acid production: the dihydrate gypsum (CaSO₄.2H₂O), and the hemihydrate gypsum (CaSO₄.½H₂O). Currently the majority of the “wet process” phosphoric acid is produced through the dihydrate route even though the hemihydrate route generates a significantly higher concentration of phosphoric acid.

With the advancements of more effective process controls, more efficient slurry cooling, and especially the realization of high product slurry re-circulations, modern plants can easily produce more than 2000 tons of P₂O₅ daily in a single line. However, two seemly formidable problems still face the industry: the high P₂O₅ losses in the byproduct and the frequent process upsets causing a lower filtration rate and even higher P₂O₅ losses. The phosphate-containing gypsum is being piled up at or near the production sites, which imposes potentially dangerous environmental hazards. The pile site is also very costly in both construction and maintenance.

Normally there is more than 4% P₂O₅ value left in the gypsum byproduct of which only a small amount is undigested phosphate ore caused by poor digestion that is environmentally “inert”. The majority of it is either the citrate-soluble P₂O₅, which occurs when the phosphate ion substitutes the sulfate at the gypsum crystal lattice during the gypsum precipitation, or the water-soluble P₂O₅, which is the result of incomplete washing of gypsum cake. The citrate and water soluble phosphates will gradually leach out of the gypsum pile and enter into either a “pond” or underground waters if no impermeable membrane is lined underneath.

It is therefore desirable to eliminate the presence of phosphate in the byproduct gypsum during phosphoric acid production. Not only is more P₂O₅ value recovered, but environmentally friendly gypsum is also produced, which can be better used for other products.

### DEFICIENCIES OF PRIOR ARTS

In the traditional “wet process” phosphoric acid production, the formation of the lost P₂O₅ occurs at two places: where the phosphate ore is digested and where the sulfuric acid is added. Due to the fast phosphate ore dissolution kinetics and the presence of sulfate in the recycled slurry, a significant amount of gypsum is precipitated when the ore is introduced. These precipitates usually take place in the vicinity of the dissolving phosphate ore particles. The highly viscous liquid medium with the presence of more than 30 wt % of gypsum crystals determines that only a laminar flow can occur in the slurry at the agitation intensity currently employed by the industry. In such a case, phosphate ions are incorporated into the gypsum lattices as precipitation occurs. Bigger and slower dissolving phosphate ore particles also have a chance to be “coated” by the precipitates, resulting in the occurrence of unreacted phosphate ore particles in the final byproduct of gypsum. The unreacted phosphate ore will generate a sulfuric acid surplus and thus causing the process to fluctuate, which in turn will produce more unreacted phosphate ore particles.

The dolomite and calcite impurities have their most significant effects on this concomitant gypsum precipitation. Their smaller particle size and faster dissolution kinetics, as compared to the phosphate ore particles, make them the more effective contributors of calcium ions. As a result, a higher supersaturation is achieved faster, resulting in gypsum fines being produced and more phosphate ore particles being coated. More significant sulfate concentration fluctuations will then occur. Other impurities like iron and aluminum will also have more pronounced effects on gypsum precipitate due to its continuous concomitant formations during the entire prolonged phosphate ore dissolution process. These impurities would have a much smaller influence over the crystallization process if there was no phosphate ore dissolution involved (when present in the ionic form).

The complexity of the concomitant phosphate ore digestion and gypsum precipitation resulted from the effects of above mentioned factors is further aggravated by the variations in the chemical compositions and the reactivity of the phosphate ore, its particle size and size distribution, as well as agitation, acid concentration, solids loading, residence time, rate of product slurry recirculation, and temperature. The process has actually become diffusion controlled and the availability of water at the vicinity of the dissolving phosphate ore particles evolves to be a significant factor in determining the filterability of gypsum crystals. The thermodynamics of the reactions on the other hand appears to play a lesser role toward the process efficiencies. So far, the effects of the above mentioned factors on the instantaneous nucleation and the subsequent crystal growth have never been fully understood for such a complicated reaction system. Up to date, because of all of these complexities, the “wet process” phosphoric acid production is greatly mystified and its control still relies on proprietary knowhows to a great extent.

In regard of the sulfuric acid addition, even with the high intensity of agitation, it is not homogenized fast enough to avoid localized supersaturations. Although short lived, such supersaturation will lead to instantaneous crystallization given the high viscosity of the slurry. Phosphate ions are more likely to be incorporated into the gypsum crystals and more gypsum fines will be produced.

The localized high degree of supersaturations, at places where the phosphate ore is added and the sulfuric acid is introduced, will not only incur high degrees of P₂O₅ losses, but also produces more amount of finer crystals. These fine crystals, even present in a small amount, can significantly reduce the gypsum cake filtration efficiencies, causing losses of water-soluble P₂O₅ value.

### SUMMARY OF THE INVENTION

It is therefore ideal to eliminate gypsum precipitation taking place at both where the phosphate ore is added and where the sulfuric acid is introduced. P₂O₅ losses will then be minimized while the filterability of gypsum crystals is enhanced. A new process for phosphoric acid production through the “wet process” is invented. This process is composed of three separate stages: (1) digesting the phosphate ore and dispersing the sulfuric acid separately and simultaneously with the gypsum slurry that has roughly stoichiometrically balanced calcium and sulfate ions in the solution and is also at considerably low supersaturation to generate the calcium containing slurry and the sulfate containing slurry respectively; (2) mixing the calcium containing slurry, i.e., the slurry carrying the digested phosphate ore, with the sulfate containing slurry, i.e., the slurry with dispersed sulfuric acid, to form the gypsum slurry that has roughly stoichiometrically balanced calcium and sulfate ions in the solution and is also at considerably low supersaturation. Part of this slurry is subsequently used to digest the phosphate ore and part of it to disperse the sulfuric acid. The remainder part is recycled back as a dilution medium for the mixing of the calcium containing slurry with the sulfate containing slurry; and (3) filtering part of the sulfuric acid dispersed slurry from stage (1) to produce the product phosphoric acid.

The flow rate of the slurry used for digesting the phosphate ore is controlled at a level that the P₂O₅ contained in this slurry is about 5-40 times more than from the phosphate ore feed. The flow rate for the slurry to disperse the sulfuric acid on the other hand is maintained at such a level that the sulfate content in this slurry is appropriate for its filtration. And the amount of the slurry recirculated for the mixing of the calcium containing and the sulfate containing slurries is about 10-50 times of the sum of the calcium containing and the sulfate containing slurries to further diminish the gypsum supersaturation.

The temperatures at the phosphate ore digestion and the slurry mixing compartments are kept about 2-10° C. higher than at the sulfuric acid dispersion region. The phosphoric acid concentration in the gypsum slurry that has roughly stoichiometrically balanced calcium and sulfate ions in the solution and is also at considerably low supersaturation is about 1-5% P₂O₅ lower than in the final slurry to be filtered.

### DESCRIPTION OF THE DRAWINGS

FIG. 1 is the Process Flow Diagram of the present invention. Calcium containing slurry from mixer 1 and sulfate containing slurry from mixer 3 are mixed in mixer 2 to form gypsum slurry that has roughly stoichiometrically balanced calcium and sulfate ions in the solution and is also at considerably low supersaturation. Part of this slurry is then flown into mixer 1 through means 5 to dissolve the phosphate ore. The ratio is such that the amount of P₂O₅ contained in the recycled slurry is about 5-40 times of the P₂O₅ contained in the phosphate ore. The other part of this slurry is cycled through means 6 to mixer 3 to maintain the sulfate level in mixer 3 at the desired level. Part of the sulfate containing slurry from mixer 3 is recycled to mixer 2 through means 7 and the other part to the filter through means 8.

FIG. 2 is a preferred process embodiment example. A round reactor 11 is equally divided by separators 12 and 13 into three sections, compartments 14, 15 and 16. However the shape of the reactor and the volume ratios of these three compartments can vary to optimize the reactions. The compartment 16 is further divided by separator 17 into 16-a and 16-b compartments. A lift-up draft tube type of agitator 18 is placed in the compartment 16-b, and the agitator 19 is used for mixing and lifting up the slurry to flow into compartment 16-a through trough 20. The slurry in compartment 16-a is agitated by agitator 21 at high intensity. Part of the slurry flow into compartments 14 and 15 through adjustable openings of 22 and 23 respectively. The majority of the slurry is recycled back to compartment 16-b through openings 27 and 28. Usually the amount of the mixed slurry recycled back is 10-50 times of the sum of the amount of the calcium containing slurry and the sulfate containing slurry. The phosphate ore and the return acid are introduced into compartment 14. Two pushing-down agitators 24 and 25 rotating in opposite directions are employed to mix the phosphate ore in compartment 14 to better defoam the slurry. The slurry carrying the digested phosphate ore flows into draft tube agitator 18 through passage 29. A “settling box” with a roof-shaped bottom in the middle covering at least two thirds of the bottom area is mounted directly outside of passage 29 (not shown in the drawing) to minimize the short circuit of phosphate ore particles. The “settling box” should be designed as such that the net slurry flow inside the box is less than 5-10 cm/s in order for phosphate ore particles of larger than 80 mesh, or 0.177 mm in equivalent diameter to settle out. Sulfuric acid is added into compartment 15 and dispersed by agitator 26. Part of the slurry from compartment 15 is drawn for filtration but the majority of it flows into draft agitator 18 through passage 30.

### DETAILED DESCRIPTION OF THE INVENTION

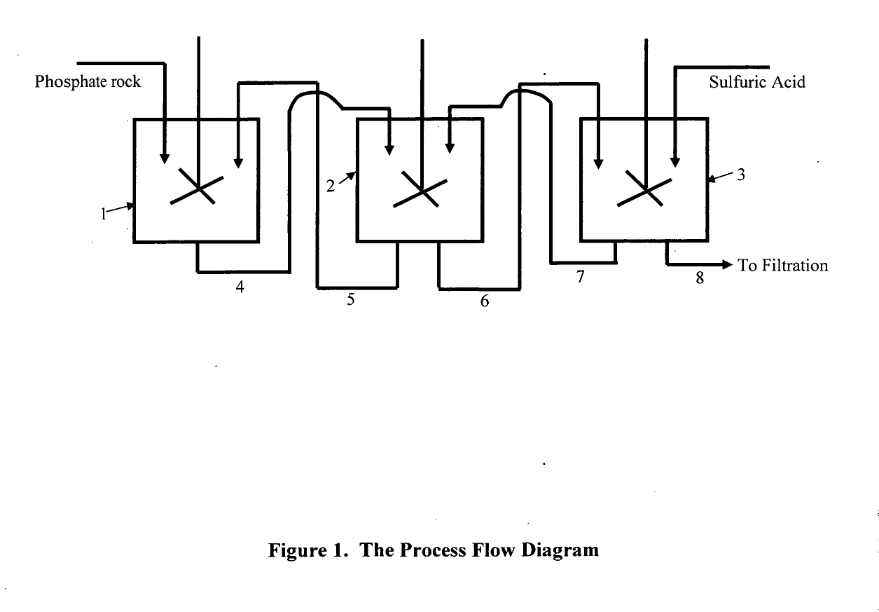

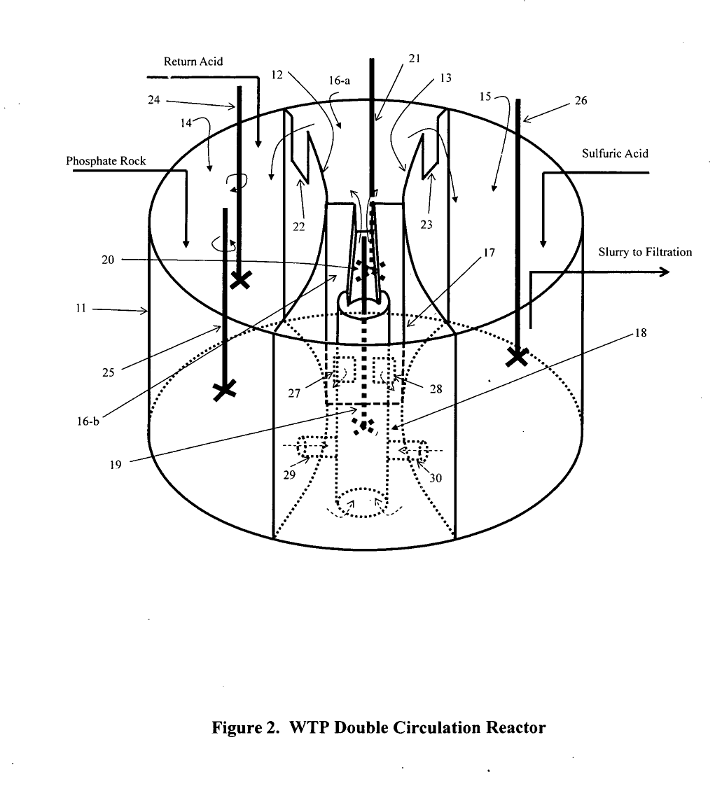

The key differences of the present invention from all the previous efforts and practices are:
(1) the usage of gypsum slurry that has roughly stoichiometrically balanced calcium and sulfate ions in the solution and is also at considerably low supersaturation to digest the phosphate ore, to disperse the sulfuric acid, and to minimize the gypsum supersaturation level through its recirculation back to where both the slurries are mixed (or through introducing both streams of the calcium containing and sulfate containing slurries into a compartment that renders a preferred average residence time of more than 20 minutes if a reactor different from the preferred embodiment described in the present invention).
It should be realized that reduction of supersaturation has long been recognized to be the key factor in improving the “wet process” phosphoric acid production efficiencies. The recirculation of product slurry is considered the fundamental success for this industry. Many other research findings and inventions have enabled the process to be reasonably effective and efficient. Practices like premixing phosphate ore with the return acid or product slurry and pre-diluting the sulfuric acid are certainly helpful.
However, these progresses indeed are far from sufficient in terms of minimizing gypsum supersaturations. The process efficiencies are therefore not maximized through these practices. In fact, premixing the phosphate ore could actually have some adverse effect when the ore is mostly consisted of fines. For the sulfuric acid pre-dilution, it could also generate some adverse effects on citrate-insoluble P₂O₅ loss due to the diminished agitation from the dilution heat.
All these limitations and dilemmas have been overcome by the present invention using the gypsum slurry that has roughly stoichiometrically balanced calcium and sulfate ions in the solution and is also at considerably low supersaturation for the phosphate ore digestions and the sulfuric acid dispersions. Only minor gypsum precipitation will occur both when the phosphate ore is added and when the sulfuric acid is introduced. The invented process flow is shown in FIG. 1, while FIG. 2 is the preferred embodiment of the invented process as a rector.
In the present invention, when the calcium containing slurry is mixed with the sulfate containing slurry, the gypsum precipitation takes place under fairly low supersaturations due to the lowered calcium and sulfate concentrations in the slurries and the recirculation of the gypsum slurry that has roughly stoichiometrically balanced calcium and sulfate ions in the solution and is also at considerably low supersaturation that is many times in volume as compared to the calcium and sulfate containing slurries. These high circulation and recirculation ratios fully diminish the gypsum supersaturations to the extent that it is even below the dihydrate re-crystallization in the hemi-dihydrate complex process. Therefore, gypsum crystal growth is promoted while its nucleation is minimized. Attritions of bigger crystals taking place at this stage due to the high circulation are actually beneficial. The fine crystal debris act as crystal growth sites to consume the calcium and sulfate ions. Bigger crystals with a narrower distribution are therefore formed, producing more filterable gypsum cake at the final separation stage.
It should be realized that most of the gypsum crystallization takes place when the calcium containing slurry mixes with the sulfate containing slurry. The filterability of gypsum cake is much less dependent on the sulfate level in the final slurry. A much lower sulfate level than the traditional values can then be employed for the slurry to be filtered. The much lessened dependency of the gypsum filterability on the free sulfate level in the final slurry also ensures the process to be much more robust toward fluctuations in both the feeding rates and the compositions of the phosphate ore and sulfuric acid. Furthermore, digesting phosphate ore with the gypsum slurry that has roughly stoichiometrically balanced calcium and sulfate ions in the solution and is also at considerably low supersaturation will significantly reduce the partitioning of impurities into the liquid phase. Cleaner product acid in terms of less impurities and lower sulfates can be produced at a lower cost.
With the elimination of high degrees of gypsum supersaturations and the additional control of sulfate level through the control of slurry flow rates, the production process becomes much easier to control. More filterable gypsum cake is therefore produced and much less P₂O₅ losses, i.e., the citrate-soluble, citrate-insoluble, and water-soluble will occur. Not only is the production rate increased, but the water balance for the operation is also improved as less amount of acid is retained in the cake after filtration. The return acid can then be made of the first wash solution, the product filtrate, and the “pond” water. The usage of “pond water” for making the return acid will solve the “pond” water problem and gain extra P₂O₅ value during the initial period when an existing plant is converted to using the present invention. Environmentally friendly gypsum is also produced, which can then be directly used for other products due to its much lower P₂O₅ contents;
(2) drawing the slurry for filtration from the sulfuric acid dispersion compartment rather than from where the reaction is supposedly completed. In addition, the present invention also uses the intermediate reactant slurry to digest the phosphate ore and to disperse the sulfuric acid separately and simultaneously. These two flow patterns are completely different from the traditional “wet process” phosphoric acid production processes, in which part of the final product slurry is drawn for filtration and the remainder part is recirculated back to consecutively digest the phosphate ore first and then to react with the sulfuric acid, and as a consequence, the concentrations of the calcium and sulfate ions fluctuate back and forth during the entire gypsum crystallization process. The level of gypsum supersaturation is not only high but also a variable. It is obvious that the changing of crystallization conditions is not favorable to forming gypsum crystals of good filterability. The present invention on the other hand provides a consistent and low supersaturation environment for the gypsum crystallization. The gypsum crystals precipitated are bigger and more uniform, and thus are easier to filter.

The slurry containing digested phosphate ore is kept at a higher temperature than the slurry with dispersed sulfuric acid. Due to the higher operating temperature possible for the phosphate ore digestion in the present invention, the total amount of heat to be removed from the system is less than the current practices. Less amount of slurry entrainment in the cooling system is therefore expected.

This invented process can be employed for both the dihydrate process and the hemihydrate process. All the existing plants can easily be converted into this process with minimal modifications to redirect the slurry flows in the reactor. Furthermore, a dihydrate production using this process can be freely converted into a hemihydrate production with no significant equipment modifications.

What is claimed is:

1) A process for reacting or mixing two or more substances to form one or more new substances, carrying out in either the aqueous, or the gaseous, or both media in combinations, or the molten state, under low supersaturations achieved through either fully or partially dispersing each or some of the substances to be reacted or mixed in the final or intermediate product stream separately and simultaneously, regardless whether such dispersion will result in chemical reactions or not, and then react or mix the substances already being dispersed in the final or intermediate product stream to produce the product.

2) A process for producing phosphoric acid through reacting phosphate rock with sulfuric acid that consists of digesting the phosphate rock and dispersing the sulfuric acid separately and simultaneously with slurry having roughly stoichiometrically balanced calcium and sulfate ions in the solution and at considerably low supersaturation, and subsequently mixing the two slurries to form the said gypsum slurry that has roughly stoichiometrically balanced calcium and sulfate ions in the solution and is also at considerably low supersaturation. This process could include any combinations of the following:
(a) recycling a part of the gypsum slurry that has roughly stoichiometrically balanced calcium and sulfate ions in the solution and is also at considerably low supersaturation into the phosphate rock digestion and the sulfuric acid addition compartments respectively. For the phosphate rock digestion, the amount of P₂O₅ contained in the recycled slurry is preferably but not limited to 5-40 times the P₂O₅ contained in the phosphate rock, and for the sulfuric acid dispersion the amount of slurry recycled is preferably but not limited to 5-15 times more than the amount of slurry being filtered;
(b) simultaneously and separately digesting the phosphate rock with the said gypsum slurry that has roughly stoichiometrically balanced calcium and sulfate ions in the solution and is also at considerably low supersaturation in the said phosphate rock digestion compartment and dispersing the sulfuric acid with the said gypsum slurry that has roughly stoichiometrically balanced calcium and sulfate ions in the solution and is also at considerably low supersaturation in the said sulfuric acid dispersion compartment;
(c) mixing the slurry coming out of the said phosphate rock digestion compartment with the slurry coming out of the said sulfuric acid dispersion compartment to form the said gypsum slurry that has roughly stoichiometrically balanced calcium and sulfate ions in the solution and is also at considerably low supersaturation. The majority part of the formed gypsum slurry is recirculated back to the mixing compartment and the remainder part is simultaneously and separately sent to the phosphate rock digestion compartment and the sulfuric acid dispersion compartment. The ratio of the said gypsum slurry that has roughly stoichiometrically balanced calcium and sulfate ions in the solution and is also at considerably low supersaturation being recirculated back to the sum of the calcium containing and the sulfate containing slurries is preferably but not limited to 10-50. If other types of reactor are used that this kind of product recirculation cannot be achieved, then the mixing compartment should render a preferably but not limited to no less than 20 minutes of average residence time;
(d) maintaining substantially higher temperature, preferably but not limited to 2-10° C., and significantly lower phosphoric acid concentration, preferably but not limited to 1-5 wt %, in the said phosphate rock digestion compartment and possibly also in the mixing compartment than in the sulfuric acid dispersion compartment;
(e) controlling the concentrations of calcium and sulfate ions in slurries in the various compartments through independently adjusting the flow rates of the recycled slurries and also through in combination with regulating the rates of phosphate rock and sulfuric acid additions to accommodate the fluctuations in the system and to achieve the optimal operational conditions;
(f) drawing the slurry for filtration from the sulfuric kid dispersion compartment where the sulfate in the solution is raised to a suitable level for the slurry filtration. Part of this slurry is used to react with the slurry from the phosphate rock digestion compartment rather than to be recycled back to carry out the next reaction cycle of digesting the phosphate rock and reacting with the sulfuric acid as in the current industrial practices.

3) An apparatus to accomplish the process stated in claim 2) that employs a lift-up draft tube to realize the slurry flow patterns and that has the compartments with controlled in&out flow patterns for the phosphate rock digestion, the sulfuric acid dispersion, and the mixing of the slurries coming from the phosphate rock digestion compartment and from the sulfuric acid dispersion compartment respectively that consists of any numbers of the following:
(a) a lift-up draft tube agitator to mix and pump the slurry into the phosphate rock digestion and the sulfuric acid dispersion compartments. The said draft tube agitator is designed to be capable of varying the slurry pumping rate and to maintain a higher slurry level in the tube to ensure a constant overflow of the slurry back into the compartment in addition to supplying the slurry for the phosphate rock digestion and sulfuric acid dispersion compartments;
(b) troughs or any other physical means with controlled in&out flow patterns to separately and simultaneously carry the slurry directly from the draft tube to the phosphate rock digestion and the sulfuric acid dispersion compartments respectively and with openings or means to allow part of the slurry to flow back to the mixing compartment;
(c) means for independent regulations of the flow rates of the said slurry streams, i.e., the said calcium containing slurry stream, the said sulfate containing slurry stream, and the recirculation stream of the said gypsum slurry that has roughly stoichiometrically balanced calcium and sulfate ions in the solution and is also at considerably low supersaturation to control the concentrations of calcium and sulfate as well as the level of gypsum supersaturation in the slurries;
(d) a settling box with a roof type of bottom in the middle covering at least two thirds of its bottom area in the phosphate rock digestion compartment for the slurry to pass through before its entering into the slurry mixing compartment to minimize short circuiting of the phosphate rock particles;
(e) dual push-down agitators rotating in the opposite directions for the agitation of the phosphate rock digestion slurry to suppress the foaming in the phosphate rock digestion compartment.
